(19) United States
(12) Patent Application Publication
(10) Pub. No.: US 2022/0073034 A1
(43) Pub. Date: Mar. 10, 2022

(54) WIPER STRUCTURE FOR RESIN WINDOW AND WIPER RUBBER

(71) Applicants: KABUSHIKI KAISHA TOYOTA JIDOSHOKKI, Kariya-shi, Aichi (JP); DENSO CORPORATION, Kariya-city, Aichi (JP)

(72) Inventors: Yusuke SHIMA, Kariya-shi, Aichi-ken (JP); Kenji TAKEMURA, Kariya-shi, Aichi-ken (JP); Naoki TORN, Kariya-city, Aichi-ken (JP); Masami MURAMATSU, Kariya-city, Aichi-ken (JP)

(73) Assignees: KABUSHIKI KAISHA TOYOTA JIDOSHOKKI, Kariya-shi, Aichi (JP); DENSO CORPORATION, Kariya-city, Aichi (JP)

(21) Appl. No.: 17/417,158

(22) PCT Filed: Dec. 2, 2019
(86) PCT No.: PCT/JP2019/047003

§ 371 Date: Jun. 22, 2021

(30) Foreign Application Priority Data
Dec. 25, 2018 (JP) 2018-240946

(51) Int. Cl. B60S 1/38; B60S 1/58

(52) U.S. Cl. CPC B60S 1/3801; B60S 2001/3836; B60S 2001/3817; B60S 1/583

(57) ABSTRACT

A wiper structure for a resin window includes a wiper configured to wipe a part of a surface of the resin window. The wiper has an elastic wiper rubber and a wiper holder configured to hold the wiper rubber. The wiper rubber has a holding base portion, a lip portion, a body portion, and a neck portion. The lip portion is in contact with the resin window. In the lip portion, a ratio of a lip length in the direction toward the surface of the resin window to a lip thickness in the thickness direction is greater than 0 and less than or equal to 2.3.

### CROSS-REFERENCE TO RELATED APPLICATIONS

The present application is a U.S. National Phase entry of, and claims priority to, PCT Application PCT/JP2019/047003, filed Dec. 2, 2019, which claims priority to Japanese Patent Application No. 2018-240946, filed Dec. 25, 2018, both of which are incorporated herein by reference in their entireties for all purposes.

### BACKGROUND

The present invention relates to a wiper structure for a resin window and a wiper rubber.

Vehicles provided with a wiper on a rear window are known. For the rear windows in recent years, a plate material made of resin may be used, rather than an inorganic glass. A wiper may include an elastic wiper rubber, such as an elongated rubber. The wiper rubber swings back and forth along a glass plate surface while being pressed against the glass plate, or the like, to wipe off rainwater, dirt, and the like off the surface of the glass plate.

If the wiper is not operated for a relatively long period of time, fine dust, such as sand or the like, easily accumulates on the surface of the wiper rubber and the surface of the glass plate. If a wiper having the accumulated dust is operated, the dust may be pressed (rubbed) on the glass plate by the wiper rubber. This may damage the surface of the glass plate. A plate material made of inorganic glass has a higher surface hardness and a smaller dynamic frictional coefficient when operating the wiper than a plate material made of resin. Therefore, since the wiper rubber slides on the surface of the inorganic glass plate with a small frictional force, noticeable scratches will less likely be formed on the surface. However, a plate material made of resin has a lower surface hardness and a greater dynamic frictional coefficient when operating wiper, as comparted to a plate material made of inorganic glass. Therefore, since the wiper blade slides with a greater frictional force than that of the inorganic class plate, noticeable scratches (scratches due to dust) will be easily formed on the surface. Accordingly, there has been a need for a wiper structure and wiper blade that are resistant to scratching a plate material made of resin.

For example, Japanese Patent Laid-Open Publication No. 2004-243917 discloses a wiper blade design method and a wiper blade. For example, a slip analysis of a wiper blade (corresponding to a wiper rubber) was performed on a prepared wiper blade model. Subsequently, the design of the wiper blade was determined by obtaining values of the design parameters based on when the characteristic value satisfies the optimum condition. As a result, the ratio of height of a neck portion to the thickness of the neck portion of the wiper blade (neck height/neck thickness) was set in the range of 2.7 to 3.7. The ratio of the height of the front end to the thickness of the front end (lip portion) of the wiper blade (lip height/lip thickness) was set in the range of 2.9 to 3.6. In this way, the design of the wiper blade satisfies the optimum condition.

However, the design method of the wiper blade and the wiper blade are directed to an inorganic glass, and no description or suggestion can be found in Japanese Patent Laid-Open Publication No. 2004-243917 about a resin window. When a wiper blade (corresponding to a wiper rubber) having a shape ratio of the lip portion (lip height/lip thickness) in the range of 2.9 to 3.6 is used for a resin window, noticeable scratches may be formed on the resin window surface.

Further, Japanese Patent Laid-Open Publication No. 2009-56925 discloses a resin window in which a protrusion strip is integrally formed. The protrusion strip is located in the vicinity of the upper portion of the lip portion of the wiper when the wiper is stopped, such that it is in a substantially horizontal posture. The protrusion strip has a protruding height that allows the lip portion to move over the protrusion strip when the wiper is operated. As the wiper moves over the protrusion, the protrusion strip and the wiper blade scatter the dust that had accumulated on the surfaces of the wiper blade. As a result, it is possible to prevent the area of the resin window surface beyond the protrusion strip from being scratched by the dust. However, since dust is retained in the area between the wiper stop position and the protrusion strip, noticeable scratches may still be formed on the resin window surface.

Further, in Japanese Utility Model Laid-Open Publication No. S63-98266, a wiper device for a vehicle is disclosed. The length of a lip portion of a wiper blade (corresponding to a wiper rubber) is set to be the shortest at the front end, the end the farthest from a pivot shaft of the wiper. The length of the lip portion gradually increases as it approaches to the pivot shaft of the wiper. This wiper device is used for a vehicle having a plate made of inorganic glass. In Japanese Utility Model Laid-Open Publication No. S63-98266, no description or suggestion of a resin window can be found. When this wiper device is used for a resin window, noticeable scratches may be formed on the resin window surface.

Therefore, in recent years, there has been a need for a wiper structure for a resin window and a wiper rubber that can prevent noticeable scratches from being formed on the surface of the resin window.

### BRIEF SUMMARY

According to one aspect of the present disclosure, a wiper structure for a resin window includes a resin window and a wiper configured to wipe a part of a surface of the resin window. The wiper has an elastic wiper rubber and a wiper holder that holds the wiper rubber. Further, the wiper has a wiper arm that allows the wiper holder and the wiper rubber to swing back and forth along the surface of the resin window while the wiper holder is being pressed against the resin window. The wiper rubber has a holding base portion, a lip portion, a body portion, and a neck portion. The holding base portion is held by the wiper holder. The lip portion contacts the resin window. The body portion extends from the lip portion toward the holding base portion. The body portion increases in thickness from the lip portion toward the holding base portion. The neck portion connects a body connecting portion of the body portion to a holding connecting portion of the holding base portion. The thickness of the neck portion is thinner than both the thickness of the body connecting portion and the thickness of the holding connecting portion. In the lip portion, a ratio of the lip length in the direction toward the surface of the resin window to the lip thickness in the thickness direction is greater than 0 and less than or equal to 2.3.

A resin window typically has a higher coefficient of friction than that of a glass plate. Therefore, when a wiper wipes the surface of the resin window, the lip portion of the wiper rubber tilts such that the contact area between the lip portion and the resin window increases, as compared to the contact area between the lip portion and a glass window. On the other hand, in the present aspect, the ratio of lip length to the lip thickness is shorter than that of a typical wiper rubber. Therefore, the wiper rubber is tilted by a smaller amount, such that the contact area between the wiper rubber and the resin window remains small. Moreover, the inventors of the present invention have made earnest studies and found that it is favorable to set the ratio of the lip length to the lip thickness to be greater than 0 and less than or equal to 2.3. As a result, the surface of the resin window can be wiped by the wiper rubber without the wiper rubber forming noticeable scratches on the surface of the resin window.

According to another aspect of the present disclosure, the resin window has a coating layer on the surface. The dynamic frictional coefficient of the coating layer with respect to the wiper rubber is in the range of 0.3 to 0.6. Therefore, the tilt angle of the lip portion of the wiper rubber with respect to the coating layer of the resin window may be set within a desirable range. Accordingly, the surface of the coating layer can be wiped by the wiper rubber without the wiper rubber forming noticeable scratches on the coating layer.

According to another aspect of the present disclosure, a wiper rubber for a resin window has a holding base portion held by a wiper holder and a lip portion located on the opposite side of the holding base portion. Further, the wiper rubber has a body portion and a neck portion. The body portion extends from the lip portion toward the holding base portion. The body portion increases in thickness from the lip portion toward the holding base portion. The neck portion connects a body connecting portion of the body portion to a holding connecting portion of the holding base portion. The neck portion has thickness thinner than both the thickness of the body connecting portion and the thickness of the holding connecting portion. In the lip portion, the ratio of the lip length, which is the length from the body portion, to the lip thickness in the thickness direction is greater than 0 and less than or equal to 2.3.

Therefore, the ratio of the lip length to the lip thickness is set to be small. Thus, while the lip portion is tilted, the contact area between the wiper rubber and the resin window remains small. Moreover, the inventors of the present invention have made earnest studies and found that it is favorable that the ratio of the lip length to the lip thickness is greater than 0 and less than or equal to 2.3. As a result, the surface of the resin window can be wiped with the wiper rubber without the wiper rubber forming noticeable scratches on the surface of the resin window.

### BRIEF DESCRIPTION OF THE DRAWINGS

FIG. 1 is a perspective view of a vehicle having a rear window and a wiper.

FIG. 2 is a rear view of the rear window and the wiper of FIG. 1, and is a view illustrating an example of a motion of the wiper and an area where noticeable scratches are easily formed on the surface of the rear window.

FIG. 3 is a view of the rear window and the wiper of FIG. 2 as seen from a direction of the arrow III.

FIG. 4 is a cross-sectional view taken along line IV-IV of FIG. 3.

FIG. 5 is a view illustrating a shape and structure of the wiper rubber.

FIG. 6 is a diagram illustrating a relationship between a wiping speed of the wiper and a frictional coefficient of an inorganic glass plate and a frictional coefficient of a resin window.

FIG. 7 is a diagram illustrating a relationship between the contact width, which is the length of the lip portion in contact with the resin window surface, and the scratch evaluation level, which indicates a scratched condition of the resin window surface.

FIG. 8 is a diagram illustrating a relationship between the ratio (L/W) of the lip length L to the lip thickness W at the lip portion and the contact width, which is the length of the lip portion in contact with the resin window surface.

FIG. 9 is an example of a combination of the resin window and the wiper rubber with the lip portion having a ratio L/W 1.7, and illustrates the condition of the surface of the resin window and the wiper rubber during wiper operation.

FIG. 10 is an enlarged view of an area X in FIG. 9, and is a view illustrating an example of a condition in which the contact width, which is a length of the lip portion in contact with the surface of the resin window in a wiping direction during wiper operation, is relatively short. It also illustrates a condition in which dust is pressed against the surface of the resin window for a relatively short period of time and over a relatively short distance (which is a condition in which noticeable scratches are less likely to be formed on the surface of the resin window).

FIG. 11 is an example of a combination of an inorganic glass plate and a wiper rubber with a lip portion ratio L/W of ≈2.5. FIG. 11 is a view illustrating a condition in which the contact width, which is the length of the lip portion in contact with the surface of the inorganic glass plate in a wiping direction during wiper operation, is relatively short.

FIG. 12 is an enlarged view of an area XII in FIG. 11. FIG. 12 is a view illustrating an example of a condition in which the contact width, which is a length of the lip portion in contact with the surface of the inorganic glass plate in a wiping direction during wiper operation, is relatively short. It is also a condition in which dust is pressed against the surface of the inorganic glass plate for a relatively short period of time and over a relatively short distance (which is a condition in which noticeable scratches are less likely to be formed on the surface of the inorganic glass).

FIG. 13 is an example of a combination of a resin window and a wiper rubber with a lip portion ratio L/W of ≈2.5. FIG. 13 is a view illustrating a condition in which the contact width, which is the length of the lip portion in contact with the surface of the resin window in a wiping direction during wiper operation, is relatively long.

FIG. 14 is an enlarged view of an area XIV in FIG. 13. FIG. 14 is a view illustrating an example of a condition in which the contact width, which is a length of the lip portion in contact with the surface of the resin window in a wiping direction during wiper operation, is relatively long. It is also a condition in which dust is pressed against the surface of the resin window for a relatively long period of time and over a relatively long distance (which is a condition in which noticeable scratches may easily be formed on the surface of the resin window).

### DETAILED DESCRIPTION

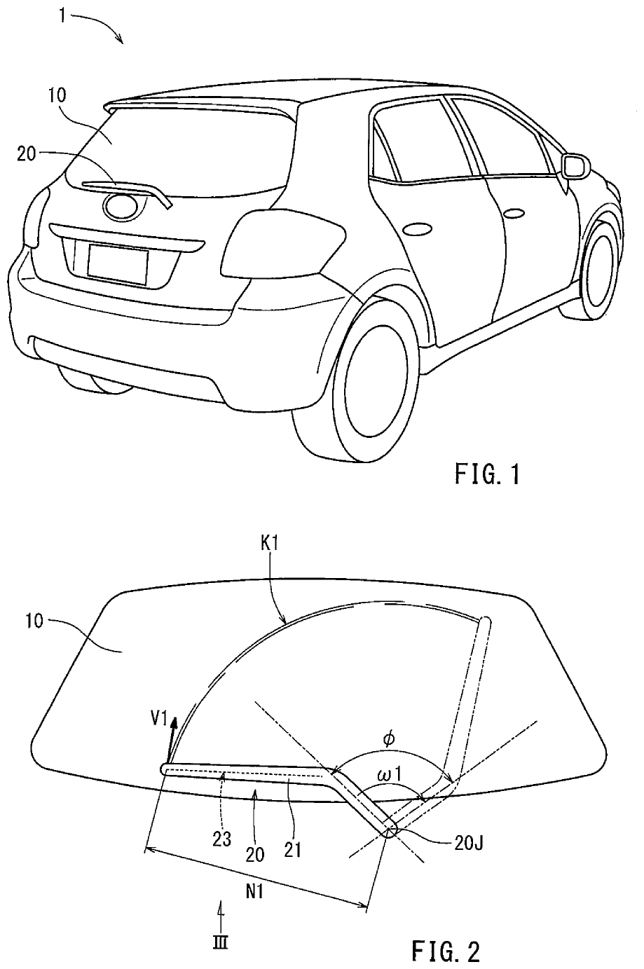

Hereinafter, an embodiment for carrying out a technology disclosed in the present specification, which is a wiper structure for a resin window and a wiper rubber, will be described with reference to the drawings. First, a rear window of a vehicle 1 (hereinafter referred to as a resin window 10) and an arrangement of a wiper 20 will be described with reference to FIG. 1. The rear window of a vehicle 1 shown as the example of FIG. 1 is a resin window 10 made of resin. A wiper 20 is arranged with respect to the resin window 10.

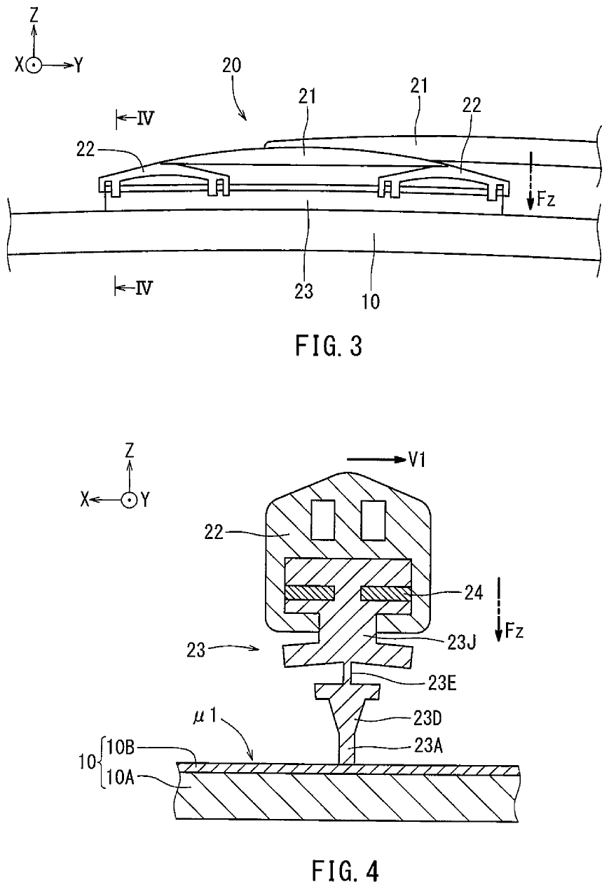

As shown in FIG. 2, the wiper 20 has a wiper rubber 23 (see FIG. 3) held in substantially a horizontal direction when the wiper 20 is in a wiper stop position (indicated by a solid line). When the wiper 20 is in operation, the wiper 20 swings back and forth about a wiper pivot shaft 20J at an angle φ. This allows the wiper 20 to wipe a part of the surface of the resin window 10.

As shown in FIG. 3, the wiper 20 has a wiper rubber 23, a wiper holder 22, a wiper arm 21, etc. FIG. 4 is a cross-sectional view taken along the line IV-IV in FIG. 3. For the sake of explanation, FIG. 4 illustrates an example of a condition in which the pressing force Fz pressing the wiper rubber 23 against the resin window 10 is zero, and the movement speed V1 to move the wiper rubber 23 along the surface of the resin window 10 is also zero.

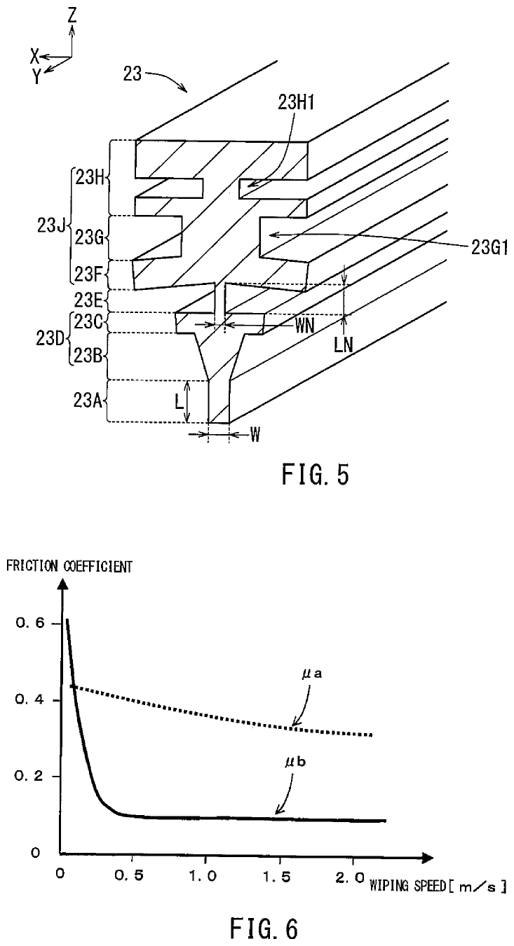

The wiper rubber 23 (also referred to as a wiper blade) is an elastic body held so as to come in contact with the resin window 10. For example, a plate 24 (see FIG. 4) made of metal may be inserted into a plate insertion groove 23H1 (see FIG. 5) of the wiper rubber 23. As shown in FIG. 4, the wiper holder 22 holds the wiper rubber 23 so that the wiper rubber 23 comes in contact with the resin window 10. As shown in FIG. 3, the wiper arm 21 supports the wiper holder 22, and presses the supported wiper holder 22 against the resin window 10 by a predetermined pressing force Fz. The wiper arm 21 allows the wiper holder 22 to swing back and forth along the surface of the resin window 10, while pressing the wiper holder 22 holding the wiper rubber 23 toward the resin window 10 during wiper operation.

As shown in FIG. 2, for example, when the wiper 20 swings at an angular velocity col and the distance from the wiper pivot shaft 20J to the front end of the wiper 20 is set to the distance N1, the maximum movement speed of the wiper 20 is a movement speed V1 at the front end of the wiper 20. This speed can be represented by V1=ω1*N1. For example, in FIG. 2, the angle φ during wiper operation is about 90°, the angular velocity col during wiper operation is about 90°/sec, and the distance N1 is about 50 cm. Further, the surface pressure of the wiper rubber 23 (which corresponds to the pressing force Fz) being pressed against the surface of the resin window 10 is about 5 to 40 N/m.

Furthermore, the resin window 10 has a resin base 10A and a coating layer 10B, as shown in FIG. 4. The coating layer 10B is formed on the surface of the resin window 10 on the side of the wiper 20. The coating layer 10B may be formed, for example, by a chemical vapor deposition method (CVD method) and mainly for the purpose of improving surface hardness. For example, a SiOx film obtained by a plasma CVD method may have various characteristics by selecting conditions, such as a silicon compound as a raw material, oxygen as a decomposition gas, a decomposition temperature, an input power, and the like.

When the wiper 20 is not used for a relatively long period of time, dust, such as sand, may accumulate on the surface of the resin window 10 and the surface of the wiper rubber 23 (see FIG. 3). When the wiper 20 is operated with the accumulated dust, a noticeable scratch K1 may be formed on the surface of the resin window 10 along the swing track near the front end of the wiper 20.

Next, an outline contour and a structure of the wiper rubber 23, etc. will be described. The front shape of the wiper rubber 23 shown in FIG. 5 has the same shape as the cross-sectional shape orthogonal to the longitudinal direction of the wiper rubber 23. The wiper rubber 23 has a lip portion 23A, a body portion 23D, a neck portion 23E, a holding base portion 23J, etc., in that order from the side closer to the resin window 10 (see FIG. 4). The material of the wiper rubber 23 may be, for example, natural rubber or a blend of natural rubber and chloroprene rubber. In the following description, “one end side” is the side close to the resin window 10 in FIG. 4, and the “other end side” is the side far from the resin window 10, as seen in FIG. 4.

As shown in FIG. 5, the lip portion 23A has a lip thickness W, which corresponds to a rubber thickness in a direction along the surface of the resin window 10 (X-axis direction, see FIG. 4) in a cross-sectional shape orthogonal to the longitudinal direction of the wiper rubber 23. The lip portion 23A has a lip length L, which corresponds to a rubber length extending in a direction toward the surface of the resin window 10 (a direction opposite to the Z-axis direction, see FIG. 4). One end side of the lip portion 23A in the lip length L direction is in contact with the resin window 10 (see FIG. 4). The wiper rubber 23 has a constant lip thickness W over the lip length L. The ratio (L/W) of the lip length L to the lip thickness W is greater than 0 and less than or equal to 2.3. An example of the wiper rubber 23 is illustrated such that the ratio of the lip length L/lip thickness W≈1.7. The reason for setting the ratio within this range will be described later.

As shown in FIG. 5, the body portion 23D has a lower body portion 23B and an upper body portion (body connecting portion) 23C, in order from the side closer to the lip portion 23A. In the cross-sectional shape orthogonal to the longitudinal direction of the wiper rubber 23, one end side of the body portion 23D is connected to the other end side of the lip portion 23A, while the other end side of the body portion 23D is connected to one end side of the neck portion 23E. The lower body portion 23B is formed to have a tapered shape, such that the rubber thickness increases toward the other end side. The rubber thickness of the body portion 23D connected to the other end side of the lip portion 23A is substantially the same as the rubber thickness (lip thickness W) of the lip portion 23A. The rubber thickness of the upper body portion 23C is set to be thicker than the rubber thickness of the lower body portion 23B.

As shown in FIG. 5, in the neck portion 23E, the rubber thickness is set to the neck thickness WN and the rubber length is set to the neck length LN in a cross-sectional shape orthogonal to the longitudinal direction of the wiper rubber 23. The neck thickness WN is set thinner than the rubber thickness on the other end side of the body portion 23D, and is set thinner than the rubber thickness on the one end side (holding connecting portion) of the holding base portion 23J. The one end side of the neck portion 23E is connected to the other end side of the body portion 23D, and the other end side of the neck portion 23E is connected to the one end side of the holding base portion 23J.

As shown in FIG. 5, the holding base portion 23J has a bottom portion 23F, a connecting portion 23G, and a head portion 23H, in this order from the side close to the lip portion 23A in the cross-sectional shape orthogonal to the longitudinal direction of the wiper rubber 23. The rubber thickness of the bottom portion 23F is set to be thicker than the rubber thickness of the upper body portion 23C. The connecting portion 23G, positioned between the bottom portion 23F and the head portion 23H, forms holder insertion grooves 23G1 extending in the longitudinal direction of the wiper rubber 23. A front end of the wiper holder 22 is inserted in the holder insertion grooves 23G1, as shown in FIG. 4. Plate insertion grooves 23H1 extending along the longitudinal direction of the wiper rubber 23 are formed in the head portion 23H. As shown in FIG. 4, each plate 24, made of metal or the like, is inserted into the each plate insertion groove 23H1. The head portion 23H of the holding base portion 23J is held by the wiper holder 22, as shown in FIG. 4.

A dynamic frictional coefficient μb of an inorganic glass plate and a dynamic frictional coefficient μa of a resin window will be described with reference to FIG. 6. FIG. 6 shows the wiping speed/dynamic frictional coefficient characteristics, represented by the relationship between the wiping speed of the wiper and the dynamic frictional coefficient. In the case of a typical rear wiper operating speed and pressing force (force of pressing the wiper against the window), the dynamic frictional coefficient μb of the inorganic glass plate is about 0.1, and the dynamic frictional coefficient μa of the resin window is in a range of about 0.3 to about 0.6. That is, the dynamic frictional coefficient μa of the resin window is about 3 to 6 times larger than the dynamic frictional coefficient μb of the inorganic glass plate. The resin window in this case has a high-hardness coating layer (for example, the above-mentioned coating layer) formed by a chemical vapor deposition method (CVD method) on the surface of the window on the side with the wiper.

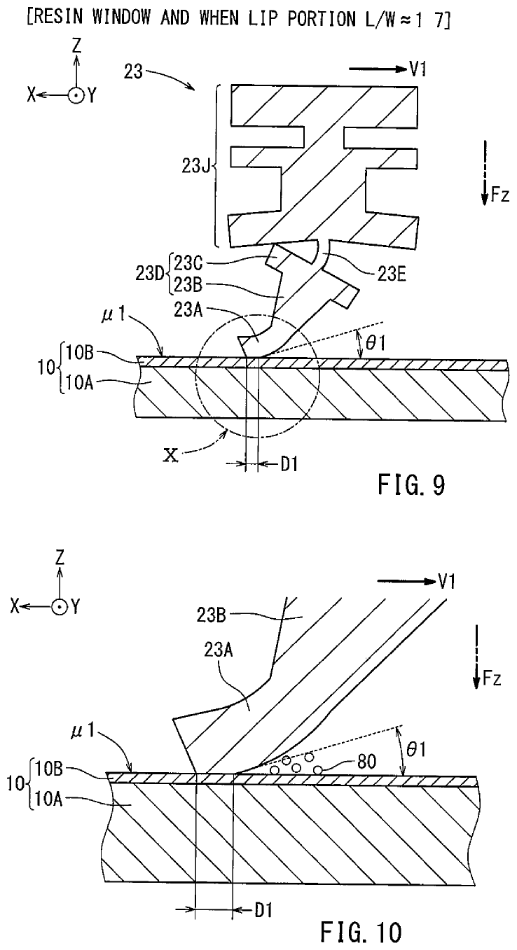

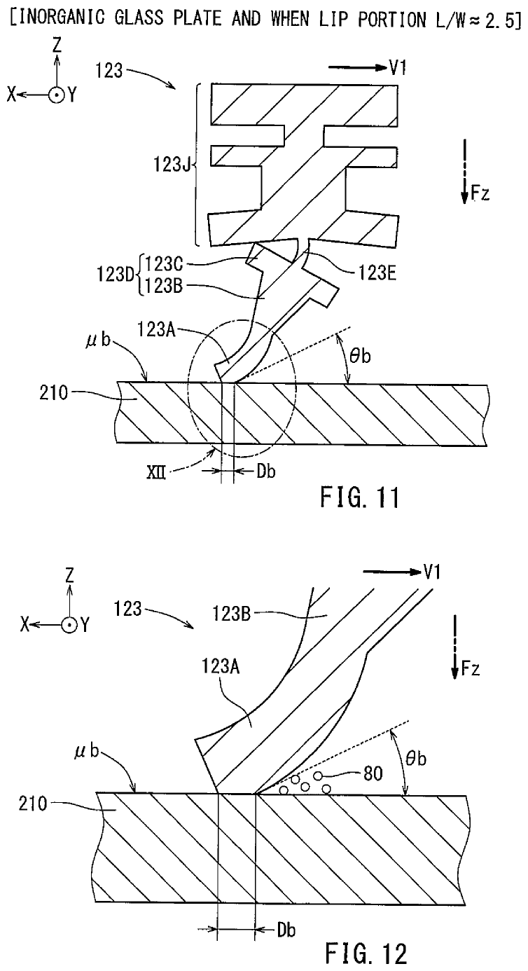

Hereinafter, an example will be described with reference to FIG. 11 and FIG. 12, where an inorganic glass plate 210 (having a dynamic frictional coefficient μb of about 0.1) and a wiper rubber 123 with a lip portion having a lip ratio L/W (see FIG. 5 for L and W)≈2.5 are combined. In this case, noticeable scratches are less likely to be formed on the surface of the inorganic glass plate 210. The wiper rubber 123 shown in FIG. 11 and FIG. 12 is different from the wiper rubber 23 of the present embodiment (see FIGS. 5 to 10, which depict an example where lip length L/lip thickness W ratio≈1.7). More specifically, the ratio (L/W) of lip length (see lip length L shown in FIG. 5) to the lip thickness of the lip portion 123A (see lip thickness W shown in FIG. 5) is about 2.5 in the example shown in FIGS. 11 and 12. The pressing force Fz pressing the wiper rubber 123 toward the inorganic glass plate 210 and the movement speed V1 for moving the wiper rubber 123 along the surface of the inorganic glass plate 210 are the same as the pressing force Fz and the movement speed V1 of the wiper rubber 23 (see FIG. 9, FIG. 10) as will be described later for this embodiment with regards to the resin window 10.

The wiper rubber 123 shown in FIGS. 11 and 12 has a lip length L/lip thickness W (see FIG. 5 for length L and width W) ratio of about 2.5. The dynamic frictional coefficient μb of the inorganic glass plate 210 with the wiper rubber 123 is about 0.1. Therefore, as shown in FIGS. 11 and 12, when the wiper rubber 123 is moved along the surface of the inorganic glass plate 210 at the movement speed V1 while being pressed against the inorganic glass plate 210 with the pressing force Fz, the lip portion 123A of the wiper rubber 123 moves relatively smoothly along the surface of the inorganic glass plate 210. At that time, the contact angle θb, which is the angle between the surface of the inorganic glass plate 210 and the vicinity of the contacting part of the lip portion 123A contacting the surface of the inorganic glass plate 210, may be, for example, about 30°. The contact width Db, which is a length (a length in the moving direction) of the contacting part of the lip portion 123A contacting the inorganic glass plate 210, may be, for example, about 1 to 2 mm. In this case, as shown in FIG. 12, even if dust 80 is present between the lip portion 123A and the surface of the inorganic glass plate 210 in the moving direction of the lip portion 123A, noticeable scratches are less likely to be formed on the surface of the inorganic glass plate 210. This is due at least in part to the contact width Db being relatively short, the period of time and the distance that the dust 80 is pressed against the inorganic glass plate 210 being short, and the surface hardness of the inorganic glass plate 210 being relatively high.

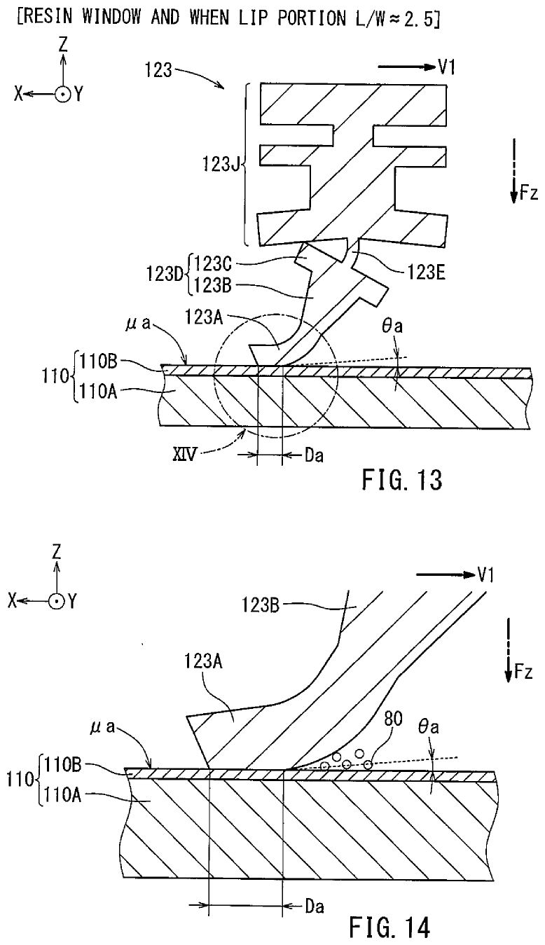

Hereinafter, an example will be described with reference to FIG. 13 and FIG. 14, where a resin window 110 (which has a dynamic frictional coefficient μa of about 0.3 to about 0.6) and a wiper rubber 123 with a lip portion having a ratio L/W (see FIG. 5 for L and W)≈2.5 are combined. In this case, noticeable scratches may be easily formed on the surface of the resin window 110. The wiper rubber 123 shown in FIGS. 13 and 14 is the same as the wiper rubber 123 shown in FIGS. 11 and 12. However, a resin window 110 is used in FIGS. 13 and 14, instead of an inorganic glass plate. The pressing force Fz and the movement speed V1 in FIGS. 13 and 14 are the same as the pressing force Fz and the movement speed V1 in FIGS. 11 and 12. In this case, the dynamic frictional coefficient μa (about 0.3 to about 0.6) of the resin window 110 is greater than the dynamic frictional coefficient μb (about 0.1) of the inorganic glass plate 210. Therefore, even if the same wiper rubber 123 as that shown in FIGS. 11 and 12 is used, the lip portion 123A is pulled by a greater force in the direction to the side opposite to the moving direction. As a result, the amount of deflection of the lip portion 123A increases, causing the contact angle θa to become smaller.

As shown in FIGS. 13 and 14, the resin window 110 has a resin base portion 110A and a coating layer 110B. The dynamic frictional coefficient μa of the surface of the coating layer 110B on the side of the wiper rubber 123 is about 0.3 to about 0.6. When the wiper rubber 123, which has a lip length L/lip thickness W ratio (see FIG. 5 for L, W) set to about 2.5, is moved on the surface of the resin window 110 at a certain movement speed V1 while being pressed against the resin window 110 with a certain pressing force Fz, the lip portion 123A of the wiper rubber 123 does not move as smoothly as it would on an inorganic glass plate 210 (which has a dynamic frictional coefficient μb of about 0.1). Therefore, the contact angle θa shown in FIGS. 13 and 14 is considerably smaller than the contact angle θb (see FIGS. 11 and 12) would have been with an inorganic glass plate 210. The contact angle θa between the wiper rubber 123 and the resin window 10 would close to zero. The contact width Da shown in FIGS. 13 and 14 is considerably longer than the contact width Db (see FIGS. 11 and 12) would be with an inorganic glass plate 210. At least partly due to the longer contact width Da between the wiper rubber 123 and the resin window 10, as shown in FIG. 14, if dust 80 is present between the lip portion 123A and the surface of the resin window 110 in the moving direction of the lip portion 123A, the period of time and distance that the dust 80 would be pressed against the resin window 110 would be considerably longer than the case of an inorganic glass plate 210. Again, this is at least partly due to the contact width Da being considerably wider than the contact width Db (see FIG. 12) would be in the case of an inorganic glass plate 210. Further, since the surface hardness of the resin window 110 is lower than that of an inorganic glass plate, noticeable scratches may be easily formed on the surface of the resin window 110.

According to the combination of the wiper rubber 23 and the resin window 10 (wiper structure for resin window) described in the present embodiment, which will be described below, the wiper rubber 23 can prevent the above-mentioned noticeable scratches from being formed on the resin window 10.

The resin window 10 may have a resin base portion 10A and a coating layer 10B, as shown in FIGS. 9 and 10. As described above, the coating layer 10B is formed by the chemical vapor deposition method (CVD method) and has a hardness higher than that of the resin base portion 10A. The dynamic frictional coefficient μl of the surface of the coating layer 10B is about 0.3 to about 0.6.

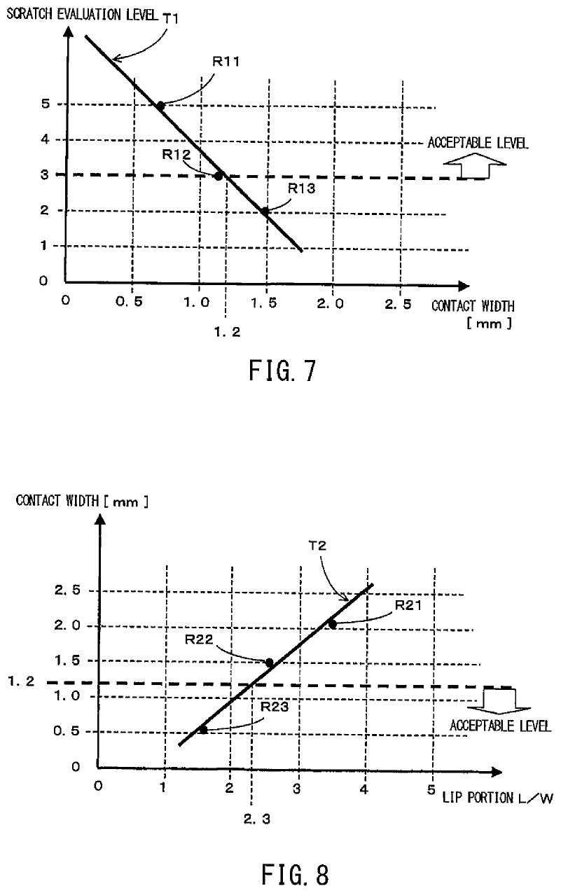

FIG. 7 shows the results obtained by experiments regarding the contact width/scratch evaluation level characteristics represented by a relationship between the contact width D1 (see FIG. 10), which is a length in a moving direction of the contacting part of the lip portion 23A with the resin window 10, and a scratch evaluation level. This relationship was tested with the wiper rubber being moved with the above-described pressing force Fz and at the above-described movement speed V1, with respect to said resin window 10. The scratch evaluation level, on a scale of 0 to 5, was set based on the number of scratches that can be visually observed in a unit area. For example, a scratch evaluation level of 5 indicates that the number of scratches in the unit area is the smallest, and a scratch evaluation level of 3 or higher is set as an acceptable level (where it is considered that noticeable scratches are less likely to be formed on the resin window). It was confirmed that an acceptable scratch evaluation level, which is 3 or higher, may be achieved if the contact width is less than or equal to 1.2 mm when the wiper rubber is moved with the above-described pressing force Fz and at the above-described movement speed of V1. This result was determined at least in part based on a regression line T1 calculated from the data R11 to R13 obtained by experimentation.

FIG. 8 shows a result obtained by the experiments regarding the lip portion ratio L/W and contact width characteristics. The graph represents a relationship between the lip length L/lip thickness W ratio (see FIG. 5 for L and W) of the lip portion 23A and the contact width D1 of the lip portion 23A with the resin window 10 when the wiper rubber is moved on the resin window 10 with a certain pressing force Fz and at a certain movement speed V1, in view of the result of FIG. 7. As a result of obtaining a regression line T2 from the experimental data points R21 to R23, it was confirmed that the lip portion ration L/W should be less than or equal to 2.3. This ratio would be needed in order to reduce the contact width obtained in FIG. 7 to less than or equal to 1.2 mm at the above-described pressing force Fz and at the above-described movement speed V1. That is, it was confirmed that the contact width can be set to less than or equal to 1.2 mm if the lip portion ratio L/W is set to greater than 0 and less than or equal to 2.3. This ensures that the scratch evaluation level is 3 or higher.

Hereinafter, an example will be described with reference to FIG. 9 and FIG. 10. In this example, a resin window 10 (which has a dynamic friction coefficient μ1 of about 0.3 to about 0.6) and a wiper rubber 23 having a lip portion 23A ratio L/W (see FIG. 5 for L and W) of ≈1.7 are combined. In this example, noticeable scratches are less likely to be formed on the surface of the resin window 10. The pressing force Fz and the movement speed V1 of the wiper rubber 23 in FIGS. 9 and 10 are the same as the pressing force Fz and the movement speed V1 of the wiper rubber 123 in FIGS. 11 and 14. According to the results shown in FIG. 7 and FIG. 8, the lip portion ratio L/W may be set to a value greater than 0 and less than and equal to 2.3. Therefore, an example will be described where the lip portion ratio L/W is set to ≈1.7. The above-described coating layer 10B is formed on the surface of the resin window 10 in this example.

As shown in FIG. 9 and FIG. 10, when a wiper rubber 23 having a lip portion ratio L/W (lip length L/lip thickness W) set to about 1.7 is moved along the surface of a resin window 10 at a certain movement speed V1 and while being pressed against the resin window 10 with a certain pressing force Fz, the lip portion 23A of the wiper rubber 23 moves smoothly. This is similar to the case of a wiper rubber 123 moving along an inorganic glass plate 210 (see FIG. 11 and FIG. 12). The contact angle θ1 with the resin window 10 shown in FIGS. 9 and 10 is approximately the same as the contact angle θb with the inorganic glass plate 210 (see FIGS. 11 and 12). As a result, the contact width D1 shown in FIGS. 9 and 10 may be less than or equal to 1.2 mm Because the contact width D1 is less than or equal to 1.2 mm, as shown in FIG. 10, even if dust 80 is present between the lip portion 23A and the surface of the resin window 10 in the moving direction of the lip portion 23A, the period of time and distance that the dust 80 is pressed against the resin window 10 will be shorter. As a result, noticeable scratches are less likely to be formed on the surface of the resin window 10.

It should also be noted that the contact width D1 gradually decreases (see FIG. 8) as the contact angle θ1 shown in FIGS. 9 and 10 gradually increases and as the lip portion ratio L/W is gradually reduced from 2.3 to 0. Therefore, as shown in FIG. 7, since the scratch evaluation level gradually increases as the contact width increases, noticeable scratches are less likely to be formed on the surface of a resin window 10 as the lip portion ratio L/W is reduced from 2.3 toward 0.

Various embodiments described in detail with reference to the accompanying drawings are representative examples of the present invention, and thus are non-limiting embodiments. The detailed description is intended to teach a person of skill in the art to make, use, and/or practice various aspects of the present teachings, and thus does not limit the scope of the disclosure in any manner. Furthermore, each of the additional features and teachings disclosed above may be applied and/or used separately or with other features and teachings in any combination thereof, to provide an improved wiper structure for a resin window and a wiper rubber and/or methods of making and using the same.

What is claimed is:

1. A wiper system, comprising:
a resin window; and
a wiper configured to wipe a part of a surface of the resin window, wherein:
the wiper comprises:
an elastic wiper rubber;
a wiper holder configured to hold the wiper rubber; and
a wiper arm configured to swing the wiper holder and the wiper rubber back and forth along the surface of the resin window while the wiper holder is pressed against the resin window,
the wiper rubber comprises:
a holding base portion held by the wiper holder;
a lip portion being in contact with the resin window;
a body portion extending from the lip portion toward the holding base portion, the body portion increasing in thickness from the lip portion toward the holding base portion; and
a neck portion configured to connect a body connecting portion of the body portion to a holding connecting portion of the holding base portion, the neck portion being thinner than both a thickness of the body connecting portion and a thickness of the holding connecting portion, and
in the lip portion, a ratio of a lip length in a direction toward the surface of the resin window to a lip thickness in a thickness direction is greater than 0 and less than or equal to 2.3.

2. The wiper system according to claim 1, wherein:
the resin window has a coating layer on the surface, and
a dynamic frictional coefficient of the coating layer with respect to the wiper rubber is 0.3 to 0.6.

3. A wiper rubber for a resin window, the wiper rubber being configured to be held by a wiper holder of a wiper that wipes a part of a surface of the resin window, the resin window having a coating layer formed on the surface, comprising:
a holding base portion configured to be held by the wiper holder;
a lip portion located on a side of wiper rubber opposite the holding base portion;
a body portion extending from the lip portion toward the holding base portion and increasing in thickness from the lip portion toward the holding base portion; and
a neck portion configured to connect a body connecting portion of the body portion to a holding connecting portion of the holding base portion, the neck portion being thinner than a thickness of the body connecting portion and a thickness of the holding connecting portion; wherein:
in the lip portion, a ratio of a lip length, said length being a length from the body portion, to a lip thickness in a thickness direction is greater than 0 and less than or equal to 2.3.

4. The wiper system according to claim 1, wherein the wiper holder is configured to press the wiper rubber against the resin window with a force of 5 to 40 N/m while the wiper rubber is being swung back and forth.

5. The wiper system according to claim 4, wherein a contact width between the wiper rubber and the resin window is less than or equal to 1.2 mm while the wiper rubber is being swung back and forth.

6. The wiper rubber according to claim 3, wherein a dynamic frictional coefficient of the coating layer of the resin window with respect to the wiper rubber is 0.3 to 0.6.

7. The wiper rubber according to claim 3, wherein the wiper holder is configured to press the lip portion against the resin window with a force of 5 to 40 N/m while the wiper rubber is being swung back and forth.

8. The wiper rubber according to claim 7, wherein a contact width between the lip portion and the resin window is less than or equal to 1.2 mm while the wiper rubber is being swung back and forth.
